(19) United States
(12) Patent Application Publication
(10) Pub. No.: US 2013/0028388 A1
(43) Pub. Date: Jan. 31, 2013

(54) FLUOROSCOPIC X-RAY APPARATUS

(71) Applicants: Koki Yoshida, Otsu-shi (JP); Yoshihide Magari, Takatsuki-shi (JP); Mitsuru Umeda, Kyoto-shi (JP)

(72) Inventors: Koki Yoshida, Otsu-shi (JP); Yoshihide Magari, Takatsuki-shi (JP); Mitsuru Umeda, Kyoto-shi (JP)

(73) Assignee: SHIMADZU CORPORATION, Kyoto-shi, Kyoto (JP)

(21) Appl. No.: 13/639,819

(22) PCT Filed: Mar. 2, 2011
(86) PCT No.: PCT/JP2011/001218

§ 371 Date: Oct. 5, 2012

(30) Foreign Application Priority Data
Apr. 7, 2010 (JP) 2010-088755

(51) Int. Cl. G21K 4/00

(52) U.S. Cl. 378/190

(57) ABSTRACT

When a multi-system setting command switch, targeted rotating position information switches, and a command executing switch are pressed down, a CPU reads out a path of frontal and lateral systems from a current position to a setting position from a setting position information memory, and reads out rotation direction and angle from a targeted position information memory. The CPU moves the frontal and lateral systems horizontally along the read-out path until the commanded setting position information conforms to detected actual position information. When the setting position information conforms to the actual position information, the frontal and lateral systems are rotated successively until the commanded rotation direction and angle conform to the detected actual position information. Thereby a fluoroscopic X-ray system can be moved smoothly from a standby position via the setting position to a targeted rotating position.

### RELATED APPLICATIONS

This application is the U.S. National Phase under 35 U.S.C. §371 of International Application No. PCT/JP2011/001218, filed on Mar. 2, 2011, which in turn claims the benefit of Japanese Application No. 2010-088755, filed on Apr. 7, 2010, the disclosures of which Applications are incorporated by reference herein.

### TECHNICAL FIELD

This invention relates to a fluoroscopic X-ray apparatus provided with a fluoroscopy system. More particularly, this invention is directed to a technique of moving a fluoroscopy system smoothly.

### BACKGROUND

Conventionally, examples of such apparatus as above include a biplane fluoroscopic X-ray apparatus having a double fluoroscopy system. See, for example, Japanese Patent Publication No. JP-A-2005-245814. Such apparatus is composed of a supporting device for supporting an X-ray tube and an X-ray detector as to face to each other. The supporting device can rotate and move horizontally relative to a subject with the back thereof being placed on a bed. The supporting device rotates in a body axis direction and around the body axis direction of the subject by a drive mechanism disposed in an operating section. The supporting device moves horizontally in a long side direction, a short side direction, and a height direction, or the like, of a top board. The drive mechanism is connected to a position detector. The position detector detects position information, such as a rotation direction, a rotation angle, a long side direction, a short side direction, and a height of the supporting device. An operator can move the supporting device into a desired position in accordance with the detected information. In addition, a region of interest of the subject conforms to ROIs of the two fluoroscopy systems by an operator. Under this state, coordinates of the ROIs can be stored.

Moreover, examples of such apparatus as above include a single plane fluoroscopic X-ray apparatus having one fluoroscopy system. In such apparatus, two or more memory switches can store targeted rotation direction and angle for the supporting device upon X-ray irradiation by an operator, the memory switches being associated with the rotation direction and angle of the supporting device. See, for example, Japanese Patent Publication No. JP-A-H08-150137.

The conventional apparatus with such construction has the following drawback. Specifically, in the conventional apparatus, when an operator moves the fluoroscopy system from a standby position to a targeted rotating position in a laboratory, the operator has to move the fluoroscopy system from the standby position into an area where fluoroscopy can be made, and thereafter, has to move the fluoroscopy system from the setting position to the targeted rotating position. That is, two operations have to be performed, which may lead to a problem that a rapid inspection cannot be conducted.

This invention has been made regarding the state of the art noted above, and one object of the invention is to provide a fluoroscopic X-ray apparatus that enables a fluoroscopy system to be moved from a standby position via a setting position to a targeted rotating position smoothly.

### SUMMARY

This invention is configured as under to achieve the above object. One example of the invention is a fluoroscopic X-ray apparatus for performing X-ray fluoroscopy on a subject in various directions. The apparatus includes a fluoroscopy system, a position detecting device, a setting position command device, a targeted rotating position command device, a command executing device, and a position control device. The fluoroscopy system is composed of a supporting device that supports an X-ray tube and an X-ray detector as to face to each other, and can rotate and move horizontally relative to the subject with the back thereof being placed on a bed. The position detecting device detects actual position information of the supporting device around the subject. The setting position command device commands setting position information associated with an area where the supporting device is set and fluoroscopy can be performed. The targeted rotating position command device commands targeted rotating position information associated with a targeted rotating position for the supporting device. The command executing device executes setting position commands and rotating position commands from the setting position command device and the targeted rotating position command device. The position control device successively performs control of horizontal movement of the supporting device such that the setting position information conforms to the actual position information outputted from the position detecting device and control of rotation of the supporting device such that the targeted rotating position information conforms to the actual position information when the command executing device executes the setting position commands and the rotating position commands.

According to the fluoroscopic X-ray apparatus in this example of the invention, the setting position command device commands the setting position information associated with the area where the supporting device is set and fluoroscopy can be performed, and the targeted rotating position command device commands the targeted rotating position information associated with the targeted rotating position for the supporting device. The command executing device executes the setting position commands and the rotating position commands by the position control device. When the setting position commands and the rotating position commands are inputted, the position control device moves the supporting device horizontally and acquires the actual position information of the supporting device that is outputted from the position detecting device. When the commanded setting position information conforms to the detected actual position information, the position control device subsequently rotates and moves the supporting device, and acquires the actual position information of the supporting device that is outputted from the position detecting device. When the commanded rotating position information conforms to the detected actual position information, the position control device stops movement of the supporting device. Consequently, the fluoroscopy system can be smoothly moved from the standby position to the targeted position.

Moreover, the setting position command device of the fluoroscopic X-ray apparatus according to this example of the invention preferably commands a path of the fluoroscopy system determined in advance between a standby position and the fluoroscopic area as the setting position information, and the targeted rotating position command device commands the rotation direction and angle of the fluoroscopy system within the fluoroscopy area as the targeted rotating position information. Thereby, the fluoroscopy system is moved horizontally along the path determined in advance between the standby position and the fluoroscopy area, and is rotated at a given rotation angle in a given rotation direction within the fluoroscopy area. Consequently, the fluoroscopy system can be moved smoothly from the standby position into a given rotation angle and a given rotation direction.

Moreover, the setting position command device of the fluoroscopic X-ray apparatus according to this example of the invention is preferably a setting memory switch associated with the setting position information, and the targeted rotating position command device is a two or more rotating memory switches associated with the targeted rotating position information. The command executing device is preferably such a memory executing switch as under. That is, upon receiving commands from both the setting memory switch and the rotating memory switches, the command executing device executes the commands from the both switches in common. Upon receiving commands from either the setting memory switch or the rotating memory switches, the command executing device executes the commands from one of the switches. Thereby, the fluoroscopy system can be moved smoothly from the standby position to the targeted position.

Moreover, in the fluoroscopic X-ray apparatus according to this example of the invention, the setting memory switch, the rotating memory switches, and the memory executing switch are preferably disposed on one operating panel. Thereby, an operator of the fluoroscopic X-ray apparatus can move the fluoroscopy system from the standby position to the targeted position with less operation.

Moreover, the fluoroscopic X-ray apparatus according to this example of the invention may include an input device, instead of the setting position command device and the targeted rotating position command device, for inputting the setting position information and the targeted rotating position information. Thereby, the fluoroscopy system can be moved from the standby position to the targeted position in accordance with the inputted setting position information and targeted rotating position information even when the setting position information and the targeted rotating position information is not determined in advance.

Moreover, the fluoroscopic X-ray apparatus according to this example of the invention preferably includes the fluoroscopy system having a double system. When the setting position command device and the targeted rotating position command device command setting positions for the double system, the position control device successively performs control of the supporting device for each the system as to move horizontally such that the setting position information conforms to the actual position information, and performs control of the supporting device for each the system as to rotate such that the targeted position information of each of the double system conforms to the actual position information. Such configuration is preferable. Thereby, in the biplane fluoroscopic X-ray apparatus, the fluoroscopy system can be moved smoothly from the standby position to the targeted position.

Moreover, the setting position command device of the fluoroscopic X-ray apparatus according to this example of the invention preferably commands a path of the fluoroscopy system determined in advance between a standby position and the fluoroscopic area as the setting position information for each of the double system, and the targeted rotating position command device commands the rotation direction and angle of the fluoroscopy system within the fluoroscopy area as the targeted rotating position information for each of the double system. Thereby, the fluoroscopy system is moved horizontally along the path determined in advance between the standby position and the fluoroscopy area, and is rotated at a given rotation angle in a given rotation direction within the fluoroscopy area. Consequently, the fluoroscopy system having a double system can be moved smoothly from the standby position into a given rotation direction at a given rotation angle.

Moreover, the fluoroscopic X-ray apparatus according to one example of this invention includes the fluoroscopy system having a double system. When the setting position command device and the targeted rotating position command device command setting positions for a single system, the position control device retracts the other system already set within the fluoroscopy area into the standby position registered in advance. Thereby, in the biplane fluoroscopic apparatus, when fluoroscopy with the single system is commanded, the other system within the fluoroscopy area is retracted into a standby position registered in advance. Consequently, upon switching the fluoroscopy with the double system into that with the single system, the fluoroscopy with the single system can be achieved with no interference by the other system. As a result, it is not necessary to operate each system independently, and thus the fluoroscopy with the double system can readily be switched into that with the single system.

Moreover, the position control device of the fluoroscopic X-ray apparatus according to this example of the invention preferably moves the fluoroscopy system along the path where the systems set in advance do not come into contact with each other. Thereby, the systems of the biplane fluoroscopy system move along the path without contacting to each other. Consequently, the fluoroscopy with the double system can readily be switched into that with the single system, and vice versa.

Moreover, the position control device of the fluoroscopic X-ray apparatus according to this example of the invention preferably calculates relative position information of each of the systems and the bed, and prevents contact of at least one system to the other system or one system to the bed in accordance with the calculated relative position information. Thereby, contact of the systems of the biplane fluoroscopy system to each other and of the biplane fluoroscopy system to the bed can be avoided upon switching between the double system and the single system.

Moreover, the setting position command device of the fluoroscopic X-ray apparatus according to the example of the invention is preferably a setting memory switch associated with the setting position information of the double system, and the targeted rotating position command device is a two or more rotating memory switches associated with the targeted rotating position information of the double system. The command executing device is preferably such a memory executing switch as under. That is, upon receiving commands from both the setting memory switch and the rotating memory switches, the command executing device executes the commands from the both in common. Upon receiving commands from either the setting memory switch or the rotating memory switches, the command executing device executes the commands from one of the switches. Thereby, the fluoroscopy system having a double system can be moved from the standby position to the targeted position. In addition, switching between the double system and the single system can be performed smoothly.

Moreover, in the fluoroscopic X-ray apparatus according to this example of the invention, the setting memory switch, the rotating memory switches, and the memory executing switch are preferably disposed on one operating panel. Thereby, an operator of the fluoroscopic X-ray apparatus can move the fluoroscopy system having a double system from the standby position to the targeted position with less operation.

Moreover, the fluoroscopic X-ray apparatus according to this example of the invention may include an input device, instead of the setting position command device and the targeted rotating position command device, for inputting the setting position information and the targeted rotating position information. Thereby, the fluoroscopy system having a double system can be moved from the standby position to the targeted position in accordance with the inputted setting position information and targeted rotating position information even when the setting position information and the targeted rotating position information is not determined in advance.

Moreover, the fluoroscopic X-ray apparatus according to this example of the invention includes the fluoroscopy system having a double system. One of the double system is preferably a ceiling-suspension type fluoroscopy system capable of travelling on the ceiling, and the other is preferably a floor-installation type fluoroscopy system capable of travelling on the floor. Thereby, the ceiling-suspension type and floor-installation type fluoroscopy systems can be moved from the standby position into a given rotation angle and a given rotation direction.

With the fluoroscopic X-ray apparatus according to this example of the invention, horizontal movement and rotation is successively controlled. Consequently, the fluoroscopy system can be moved from the standby position via the setting position into the targeted rotating position.

### BRIEF DESCRIPTION OF THE DRAWINGS

FIG. 1 is a perspective view of a schematic construction of a fluoroscopic X-ray apparatus according to one example of this invention.

FIG. 2A is a side view showing a drive mechanism of a frontal system. FIG. 2B is a side view showing a drive mechanism of a lateral system.

FIG. 3 is a schematic block diagram of a control system of the apparatus.

FIG. 4 is a perspective view showing a schematic construction of an operating section.

FIG. 5 is a schematic view showing contents of a memory.

FIG. 6 is a schematic plan view showing a moving path of the frontal and lateral systems.

FIGS. 7 through 11 are schematic plan views each showing another moving path of the frontal and lateral systems.

FIG. 12 is a flow chart showing operations of the fluoroscopic X-ray apparatus.

### DESCRIPTION OF REFERENCES

23 . . . C-shaped arm
24 . . . X-ray tube (C-shaped arm side)
25 . . . FPD (C-shaped arm side)
34 . . . Ω-shaped arm
35 . . . X-ray Tube (Ω-shaped arm side)
36 . . . FPD (Ω-shaped arm side)
40 . . . operating panel
41 . . . CPU
43 . . . targeted rotating position information memory
45 . . . setting position information memory
M1 to M4 . . . drive motor
D1 to D4 . . . rotary encoder

### DETAILED DESCRIPTION

### Examples

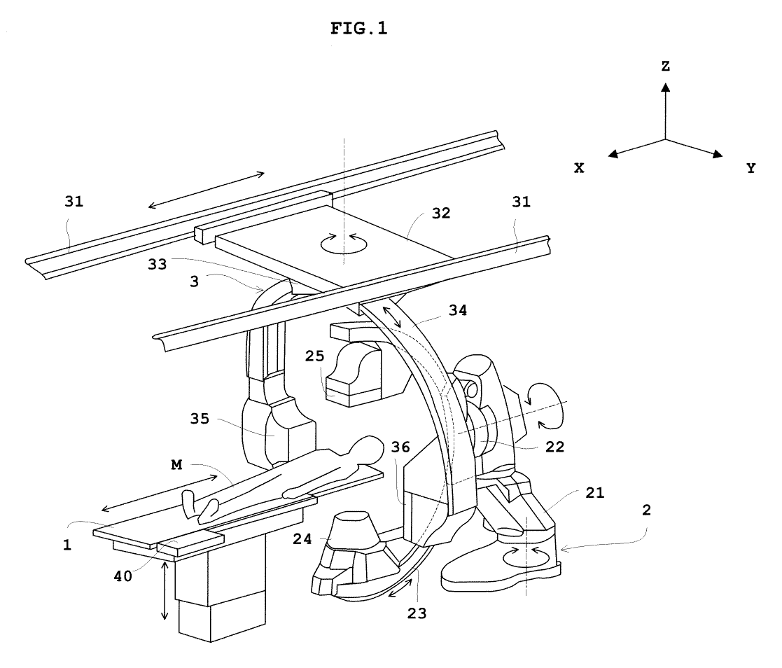

One example of this invention is to be described in detail hereinafter with reference to the drawings. FIG. 1 is a perspective view showing a schematic construction of a fluoroscopic X-ray apparatus according to one example of this invention.

An C-shaped arm is denoted by the reference 23 that can move around a subject M with the back thereof being placed on a bed 1. The C-shaped aim 23 is pivotally supported by a base 21 disposed on the floor, and a C-shaped arm supporting section 22 held on the base 21. The C-shaped arm 23 supports at both ends thereof an X-ray tube 24 and a flat-panel C-ray detector (hereinafter, referred to as an “FPD”) 25 as to face to each other across a frontal region of head of the subject M. The C-shaped arm 23, the X-ray tube 24, and the FPD 25 form an X-ray fluoroscopy system 2 (hereinafter, referred to as a frontal system 2.) Moreover, an Ω-shaped arm is denoted by the reference 34 that can move around the subject M with the back thereof being placed on the bed 1. The Ω-shaped arm 34 is movably supported by a rail 31 disposed on the ceiling, a movable board 32 held by the rail 31, a movable rail, not shown, held by the movable board 32, and an Ω-shaped arm supporting section 33 held by the movable rail. The Ω-shaped arm 34 supports at both ends thereof an X-ray tube 35 and an FPD 36 as to face to each other across a temporal region of head of the subject M. The Ω-shaped arm 34, the X-ray tube 35, and the FPD 36 forms an X-ray fluoroscopy system 3 (hereinafter, referred to as a lateral system 3.) The operating panel 40 is disposed on a side edge of the bed 1. Here, the frontal system 2 and the lateral system 3 correspond to the fluoroscopy system in this example of the invention. The C-shaped arm supporting section 22 and the Ω-shaped arm supporting section 33 correspond to the supporting device in this example of the invention.

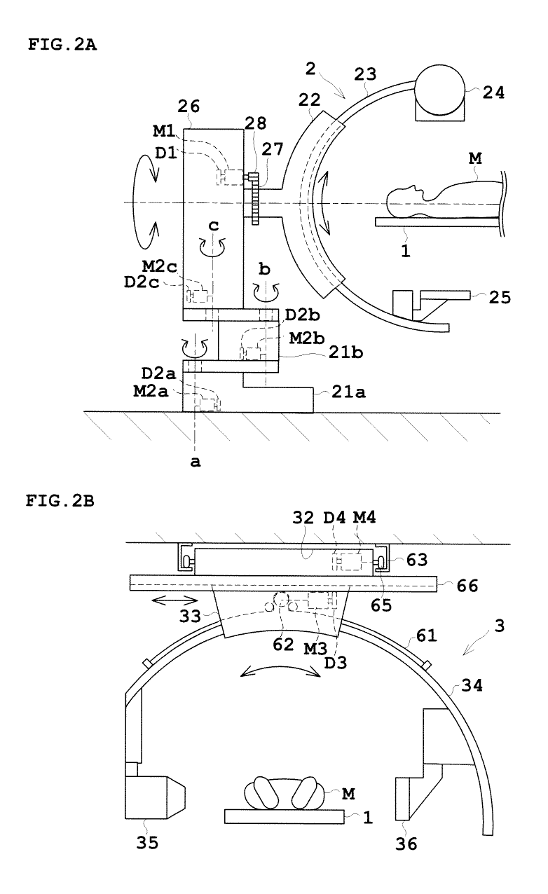

Next, driving mechanisms of the frontal system 2 and the lateral system 3 will be described with reference to FIG. 2. FIG. 2A is a side view showing a drive mechanism of the frontal system 2. FIG. 2B is a side view showing a drive mechanism of the lateral system 3.

The C-shaped arm supporting section 22 rotates around a body axis of the subject M, whereby the C-shaped arm 23 rotates around the body axis of the subject M. A base of the C-shaped arm supporting section 22 (a surface opposite to the surface where the C-shaped arm 2 is held) is pivotally disposed on a side of a strut 26. A gear 27 is provided adjacent a support face on the side of the strut 26, where the C-shaped arm 2 is held. The gear 27 is engaged with a pinion gear 28. The pinion gear 28 is attached to an output shaft of a drive motor M1 in the strut. Rotation of the drive motor M1 causes the C-shaped arm 23 to rotate around the body axis of the subject M along with the C-shaped arm supporting section 22. Moreover, a rotary encoder D1 is provided that detects a rotation direction and a rotation angle of the drive motor M1. Here, the C-shaped arm 22 can rotate in a body axis direction of the subject by a drive mechanism, not shown.

The C-shaped arm 23 can be moved horizontally with a linkage mechanism having three rotation axes a, b, and c. The linkage mechanism can achieve horizontal movement through rotation of drive motors M2a, M2b, M2c (collectively referred to as M2) in the bases 21a, 21b and the strut 26, respectively. Here, the motor M2 is connected to rotary encoders D21, D2b, D2c (collectively referred to as a rotary encoder D2) for detecting rotation direction and angle of the drive motor M2.

The Ω-shaped arm 34 can rotate around the body axis of the subject M through a drive mechanism in the Ω-shaped arm supporting section 33. A belt 61 (or chain) is partially housed in the Ω-shaped arm supporting section 33, both ends of the belt 61 being fixed to the Ω-shaped arm 34. The belt 61 is suspended over a driving roller 62. The Ω-shaped aim supporting section 33 includes therein a rotary encoder D3 that detects rotation direction and angle of a drive motor M3 for rotating the drive roller 62. Rotation of the drive motor M3 causes the Ω-shaped arm 34 to rotate around the body axis of the subject M via the belt 61.

Among horizontal movement of the Ω-shaped arm 34, horizontal movement in a long side direction relative to the bed 1 can be achieved through a rail 63 on the ceiling and a drive mechanism in the movable board 32. The Ω-shaped arm 34 includes wheels 65 on both sides facing to the rail 63. The wheels 65 are attached to an output shaft of a drive motor M4 in the movable board 32. Rotation of the motor M4 causes the Ω-shaped arm 34 to move horizontally along the rail 63. The drive motor M4 is connected to a rotary encoder D4 that detects rotation direction and angle of the motor M4. Moreover, horizontal movement of the Ω-shaped arm 34 in a short side direction relative to the bed 1 can be achieved through a movable rail 66 in the movable board 32 and a drive mechanism in the Ω-shaped arm supporting section 33. The drive mechanism in the Ω-shaped arm supporting section 33 has the same configuration same as the foregoing drive mechanism in movable board 32, and thus explanation thereof is to be omitted for avoiding overlapping descriptions.

The drive motors M1 to M4, the rotary encoders D1 to D4, and a CPU 41 to be mentioned later, form a servo mechanism. The servo mechanism can move the C-shaped arm 23 and the Ω-shaped arm 34 into a given position. Here, the rotary encoders D1 to D4 correspond to the position detecting device in this example of the invention.

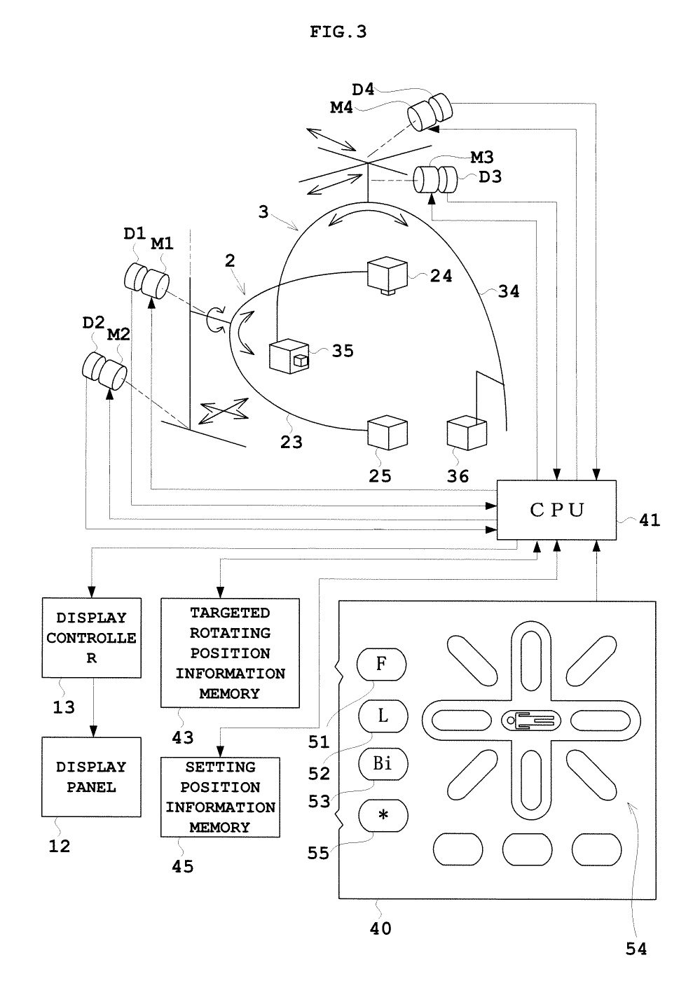

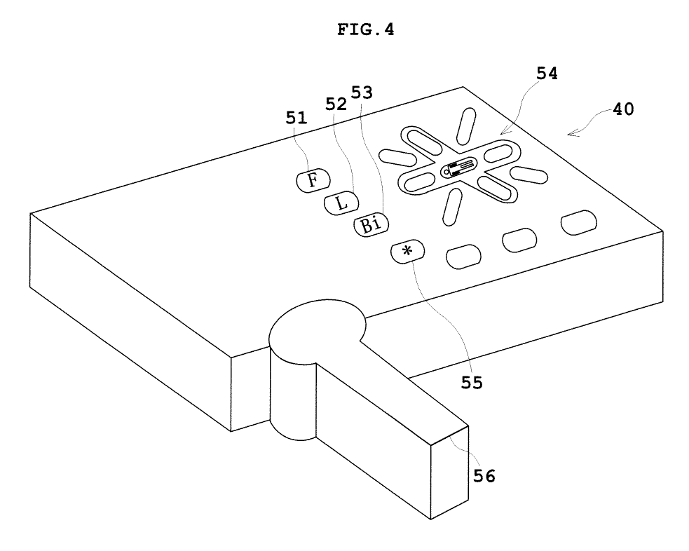

Next, description will be given of control systems for controlling each rotation mentioned above with reference to FIGS. 3 and 4.

As shown in FIG. 4, the operating panel 40 includes thereon a frontal-system setting command switch 51, a lateral-system setting command switch 52, a multi-system setting command switch 53, targeted rotating position command switches 54, and a command executing switch 55. The frontal-system setting command switch 51 stores a state as setting position information where only the frontal system 2 is set within an area in which fluoroscopy can be performed (hereinafter, referred to as an imaging area.) The lateral-system setting command switch 52 stores a state as setting position information where only the lateral system 3 is set within the imaging area. The multi-system setting command switch 53 stores a state as setting position information where the frontal system 2 and the lateral system 3 are set within the imaging area. The targeted rotating position command switches 54 store a clinical angle of the frontal system 2 and the lateral system 3 as targeted rotating position information in association with nine memory switches. The command executing switch 55 executes commands of the switches 51 to 54. As above, the setting position information is associated with the area where the frontal system 2 and the lateral system 3 are set and fluoroscopy can be performed (imaging area). The targeted rotating position information is associated with the targeted rotating position of the frontal system 2 and the lateral system 3 (clinical angle). Moreover, the operating panel 40 includes on the side thereof a grip 56 for inputting setting positions in the long and short side directions and rotation direction and position of the C-shaped arm 33 and the Ω-shaped arm 34.

The frontal-system setting command switch 51, the lateral-system setting command switch 52, and the double-system setting command switch 53 have a function of commanding the setting position information of the frontal system 2 and the lateral system 3. The targeted rotating position command switches 54 have a function of commanding the targeted rotating position information of the frontal system 2 and the lateral system 3. Here, the frontal-system setting command switch 51, the lateral-system setting commanding 52, the double-system setting commanding 53, and the targeted rotating position command switches 54 correspond to the setting position command device and the targeted rotating position command device in this example of the invention. The command executing switch 55 corresponds to the command executing device in this example of the invention.

Reference is made again to FIG. 3. The CPU 41 inputs the setting position information and the targeted rotating position information outputted from the operating panel 40 for controlling the actual position information detected from the rotary encoders D1, D2, D3, and D4 as drive direction and drive quantity of the drive motors M1, M2, M3, and M4. The CPU 41 performs control such that the actual position information conforms to the targeted rotating position information. Here, the CPU 41 corresponds to the position control device in this example of the invention.

A display panel 12 displays rotation direction and angle of the drive motors M1 to M4 as the actual position information, and displays position information stored in the frontal-system setting command switch 51, the lateral-system setting command switch 52, the double-system setting command switch 53, and the targeted rotating position command switches 54. The display panel 12 displays position information of the frontal system 2 and the lateral system 3 to an operator.

A display controller 13 blinkingly displays the rotation direction and angle while the CPU 41 performs control such that the actual position information conforms to the setting position information or the targeted rotating position information. When the actual position information conforms to the information, the display controller 13 controls the display of the rotation direction and angle as to stop blinking and light up. That is, the display controller 13 controls the display panel 12.

A targeted rotating position information memory 43 stores targeted rotating position information in response to the targeted rotating position command switch 54 on the operating panel 40. When the targeted rotating position information corresponding to the clinical angle is inputted through the grip 56 into the operating panel 40, and one of the nine targeted rotating position command switches 54 is pushed for a long time, the targeted rotating position information is stored in an address corresponding to the switch pushed for a long time. Thus, the targeted rotating position information is to be stored.

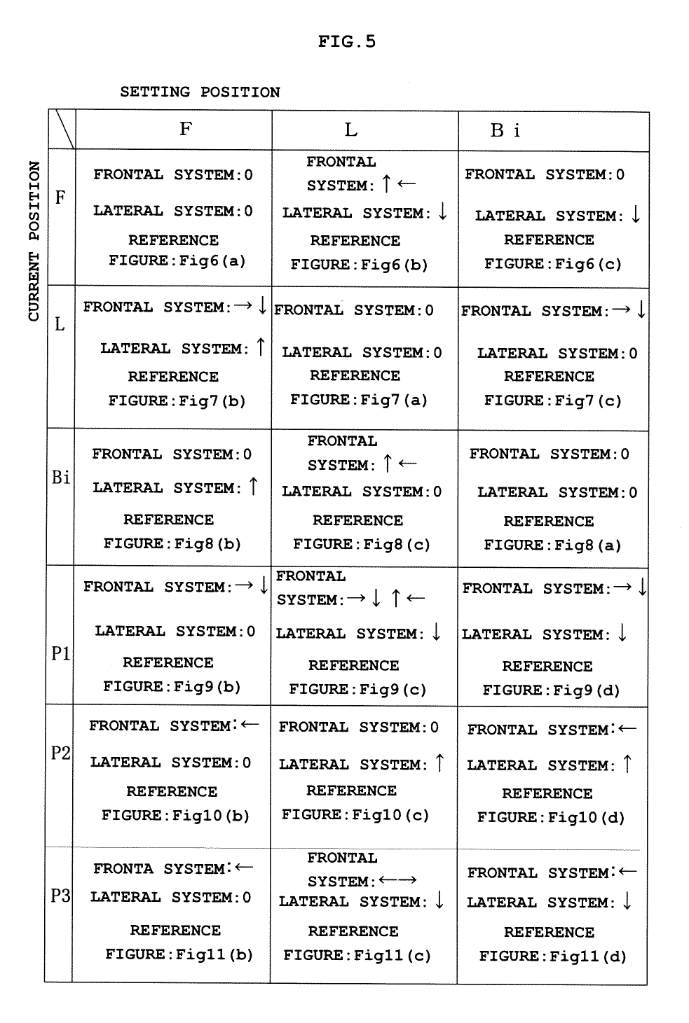

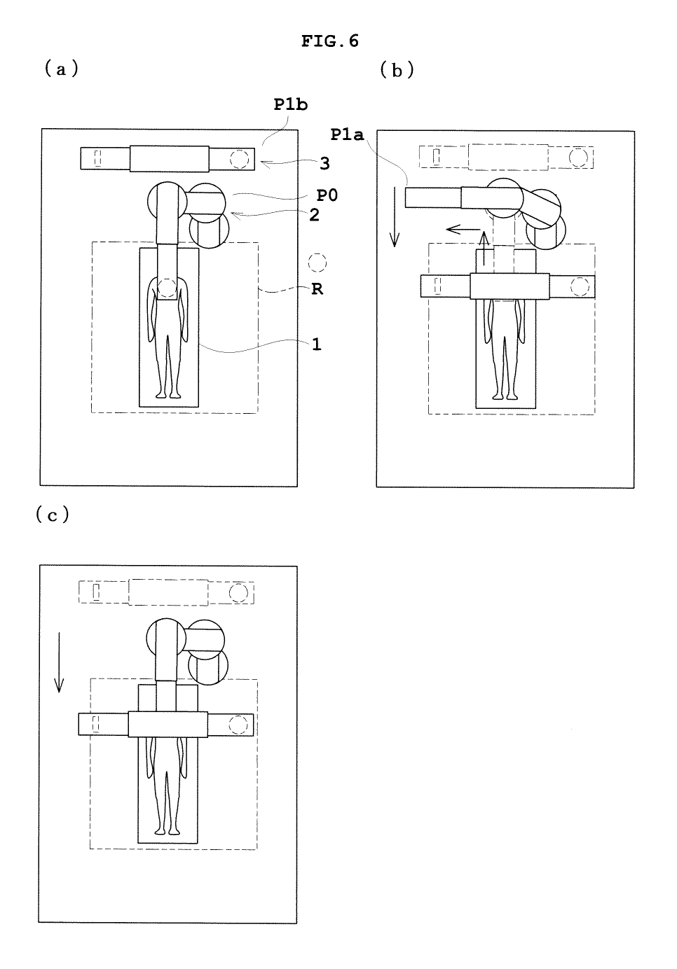

A setting position information memory 45 stores paths of the frontal system 2 and the lateral system 3 from the current position to a commanded setting position. FIG. 5 schematically shows memory contents of the setting position information memory 45. In FIG. 5, forward movement of the bed 1 in FIG. 6 to FIG. 11 (head side of the subject M) is denoted by an up arrow, and backward movement of the bed 1 (foot side of the subject M) is denoted by a down arrow. Movement of the bed 1 in the short side direction is denoted by right and left arrows. The timing of movement denoted by each arrows is to be mentioned later with reference to FIG. 6 to FIG. 11. In the drawings, denoted by F is a state where the frontal system 2 is set within a setting position P0 of the imaging area R and the lateral system 3 is set within a standby position P1b registered in advance, mentioned later. Denoted by L is a state where the lateral system 3 is set within the imaging area R and the frontal system 2 is set within a standby position P1a registered in advance, mentioned later. Denoted by Bi is a state where both systems are set within the imaging area R. Denoted by P1 is a state where both systems are not set within the imaging area R but set within the standby positions P1a, P1b registered in advance, mentioned later. Denoted by P2 is a state where both systems are not set within the imaging area R but set within standby positions P2a, P2b different from P1, mentioned later. Denoted by P3 is a state where one system is in the setting position or the standby position P1, and the other system is in the standby position P2 different from the setting position and the standby position P1.

Next, description will be given of the paths of the frontal system 2 and the lateral system 3 from the current position to the commanded setting position with reference to FIGS. 6 through 10. In FIGS. 6 through 10, it is assumed that the imaging area R is an area where the subject M is placed with the back thereof on the bed 1 in the laboratory and where the X-ray tube 24 and the FPD 25 as well as the X-ray tube 25 and the FPD 36 are arranged around the bed 1 as to face to each other. The setting position is set in any position within the imaging area R.

In FIGS. 6A through 6C, only the frontal system 2 is set in the setting position P0 within the imaging area R and the lateral system 3 is set in the standby position P1b. Such state is assumed as the current position (i.e., the state F mentioned above.) When the frontal-system setting command switch 51 is pressed down, since the current position and the commanded setting position P0 is identical, both the frontal system 2 and the lateral system 3 do not move as shown in FIG. 6A. When the lateral-system setting command switch 52 is pressed down, the frontal system 2 different from the system to be commanded has already been set within the imaging area R. Here when the frontal system 2 is firstly moved into the standby position P1a, the frontal system 2 impacts the lateral system 3 upon horizontally moving of the lateral system 3 into the imaging area R. Thus, the CPU 41 controls movement of the frontal system 2 and the lateral system 3 so as not to contact with each other, which is to be mentioned later. Specifically, as shown in FIG. 6B, the lateral system 3 is moved horizontally into the imaging area R under a state where the frontal system 2 is set in the setting position P0.

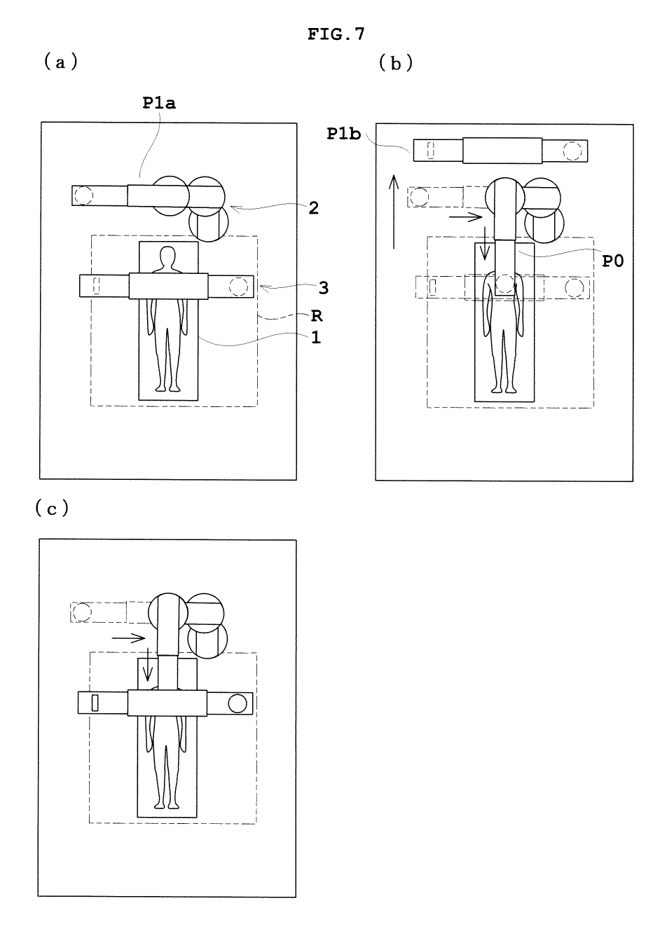

The lateral system 3 is set into the commanded setting position, and thereafter, the frontal system 2 is retracted into the standby position P1a registered in advance. Here, setting of the frontal system 2 within the imaging area R is detected through output of the rotary encoder D2. Subsequently, when the multi-system setting command switch 53 is pressed down, since the frontal system 2 has already been set in the setting position PO within the imaging area R. horizontal movement of the lateral system 3 into the setting position can achieve setting of both the systems within the imaging area R, as shown in FIG. 6C. When the targeted rotating position command switch 54 is pressed down with each setting command switch, the frontal system 2 and the lateral system 3 rotate from each setting position into the targeted rotating position. Hereinafter, the same description will be made for FIGS. 7 through 11.

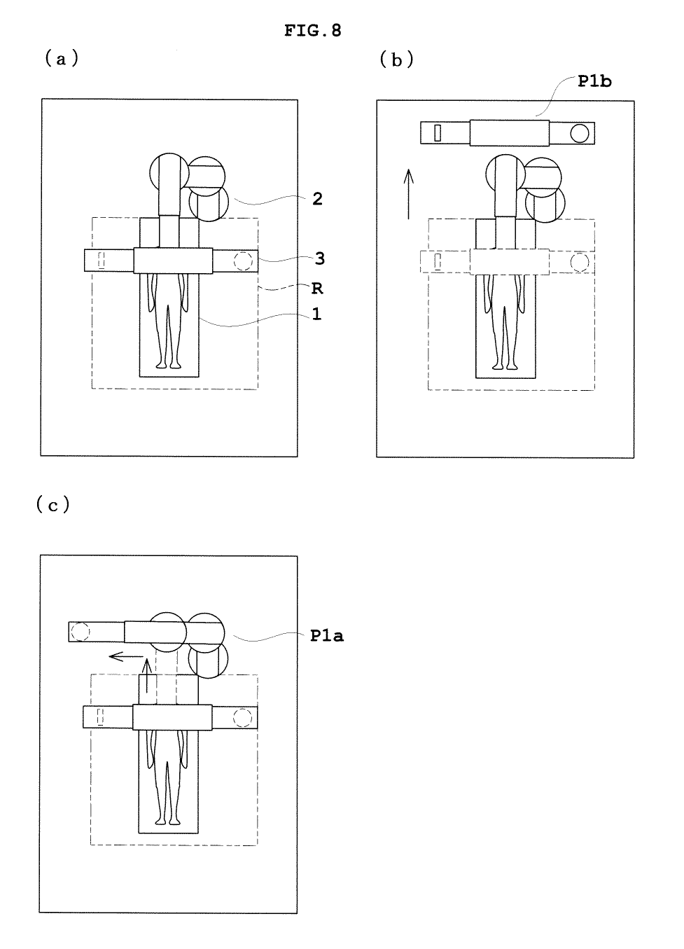

In FIGS. 7A through 7C, only the lateral system 3 is set within the imaging area R and the frontal system 2 is set in the standby position P1a. Such state is assumed as the current position (i.e., the state L mentioned above.) When the lateral-system setting command switch 52 is pressed down, since the current position and the commanded setting position is identical, both the frontal system 2 and the lateral system 3 do not move as shown in FIG. 6A. When the frontal-system setting command switch 51 is pressed down, since the lateral system 3 has already been set within the imaging area R, the frontal system 2 is moved into the setting position P0 and thereafter the lateral system 3 is retracted into the standby position P1b registered in advance, as shown in FIG. 7B. Subsequently, when the multi-system setting command switch 53 is pressed down, since the lateral system 3 has already been set within the imaging area R, movement of the frontal system 2 into the setting position P0 can achieve setting of both the systems within the imaging area R, as shown in FIG. 7C. Here, upon movement of the frontal system 2, the CPU 41 controls movement of the frontal system 2 and the lateral system 3 so as not to contact with each other, which is to be mentioned later. Hereinafter, the same description will be made for FIGS. 8 through 11.

In FIGS. 8A through 8C, both the frontal system 2 and the lateral system 3 are set within the imaging area R. Such state is assumed as the current position (i.e., the state Bi mentioned above.) When the multi-system setting command switch 53 is pressed down, since the current position and the commanded setting position is identical, both the frontal system 2 and the lateral system 3 do not move as shown in FIG. 8A. When the frontal-system setting command switch 51 is pressed down, since the frontal system 2 and the lateral system 3 have already been set within the imaging area R, the lateral system 3 is retracted into the standby position P1b registered in advance, as shown in FIG. 8B. When the lateral-system setting command switch 52 is pressed down, the frontal system 2 is retracted into the standby position P1a registered in advance, as shown in FIG. 8C.

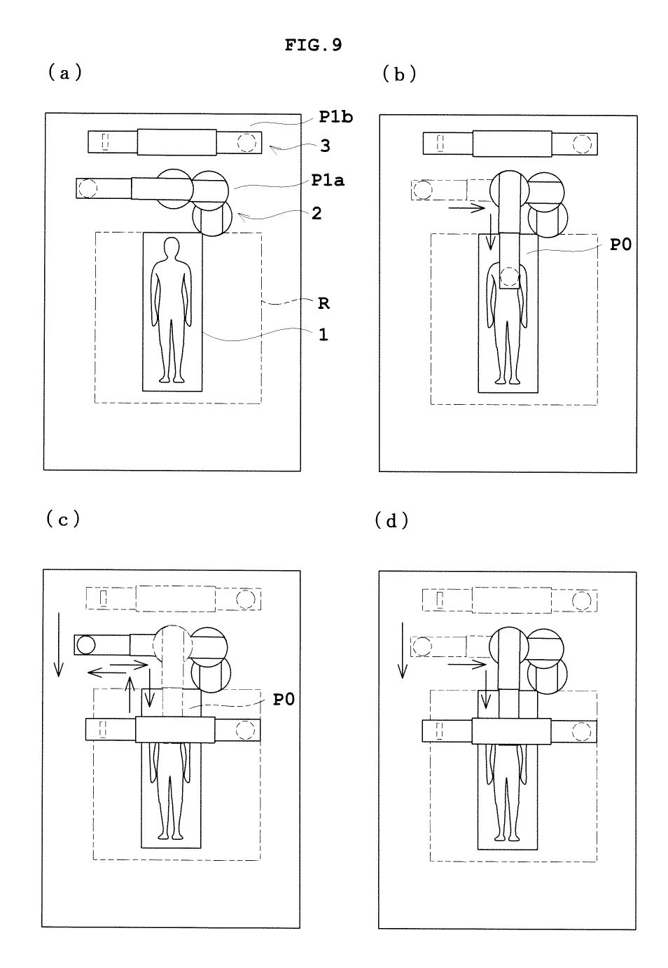

In FIG. 9B to 9D, the frontal system 2 is set in the standby position P1a in front of the bed 1 as shown in FIG. 9A. The lateral system 3 is set in the standby position P1b in front of the standby position P1a of the frontal system 2. Such state is assumed as the current position (i.e., the state P1 mentioned above.) When the frontal-system setting command switch 51 is pressed down, the frontal system 2 is moved from the standby position P1a into the setting position P0 within the imaging area R as shown in FIG. 9B. When the lateral-system setting command switch 52 is pressed down, the frontal system 2 is moved from the standby position P1a into the setting position P0, and thereafter the lateral system 3 is horizontally moved from the standby position P1b into the imaging area R as shown in FIG. 9C. The lateral system 3 is set in the commanded setting position, and then the frontal system s retracted into the standby position P1a again. When the multi-system setting command switch 53 is pressed down, the frontal system 2 is moved from the standby position P1a into the setting position P0 within the imaging area R, and thereafter the lateral system 3 is horizontally moved from the standby position P1b into the imaging area R as shown in FIG. 9D.

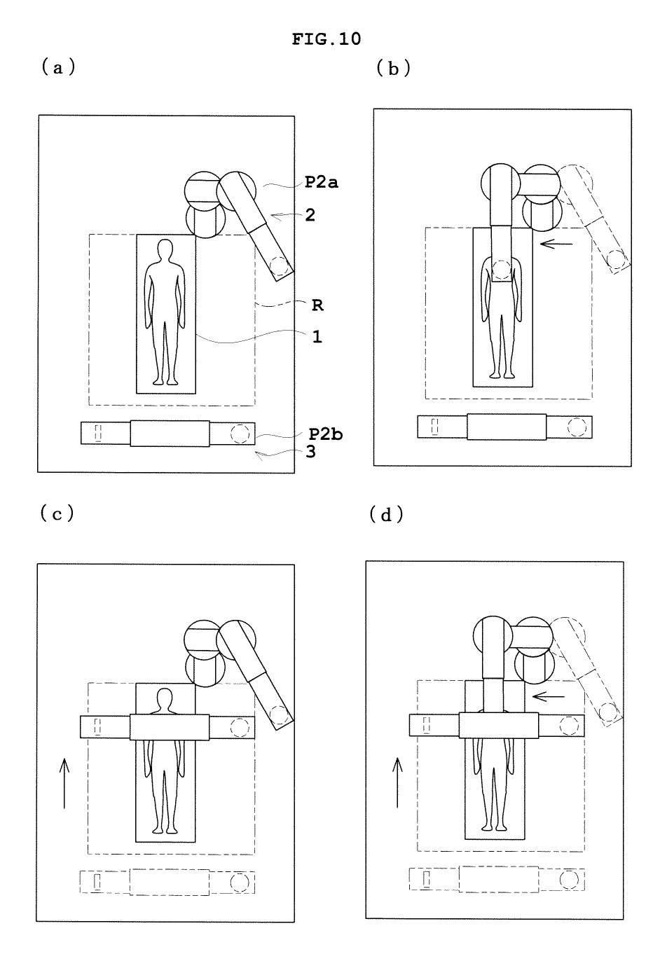

In FIG. 10B to 10D, both the frontal system 2 and the lateral system 3 are not set within the imaging area R as shown in FIG. 10A. The frontal system 2 is set in the standby position P2a on the side of the bed 1, and the lateral system 3 is set in the standby position P2b behind the bend 1. Such state is assumed as the current position (i.e., the state P2 mentioned above.) When the frontal-system setting command switch 51 is pressed down, the frontal system 2 is moved into the setting position PO within the imaging area R as shown in FIG. 10B. When the lateral-system setting command switch 52 is pressed down, the lateral system 3 is horizontally moved into the imaging area R as shown in FIG. 10C. When the multi-system setting command switch 53 is pressed down, the frontal system 2 is moved into the setting position P0 within the imaging area R, and thereafter the lateral system 3 is horizontally moved into the imaging area R as shown in FIG. 10D.

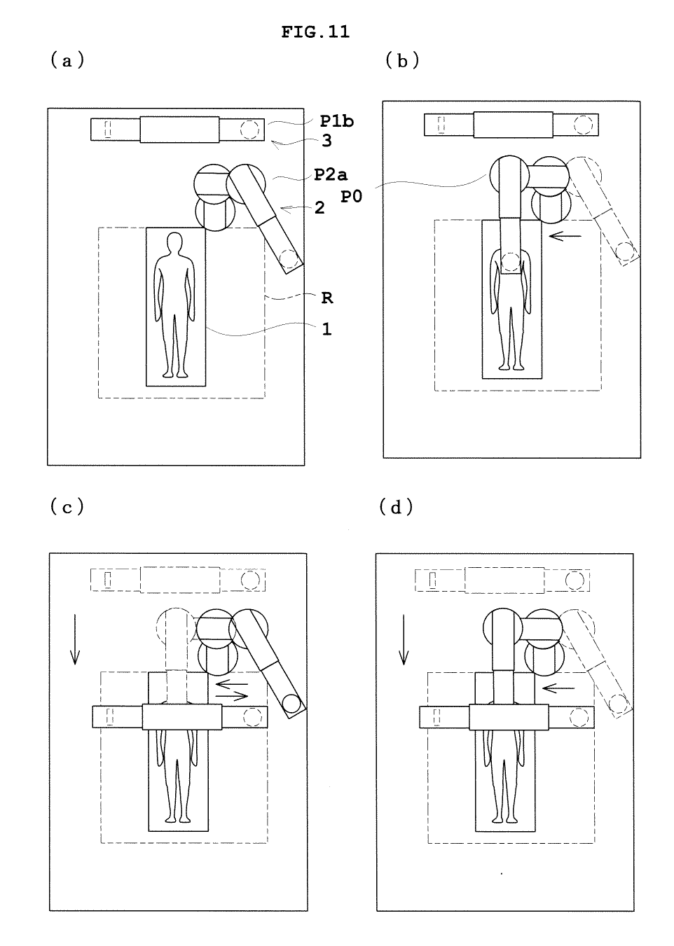

In FIGS. 11B to 11D, one of the systems, i.e., the lateral system 3 is set in the standby position P1b, and the other frontal system 2 is set in another standby position P2a as shown in FIG. 11A. Such state is assumed as the current position (i.e., the state P3 mentioned above.) When the frontal-system setting command switch 51 is pressed down, the frontal system 2 is moved into the setting position PO within the imaging area R as shown in FIG. 11B. When the lateral-system setting command switch 52 is pressed down, the frontal system 2 is firstly moved into the setting position P0 within the imaging area, and thereafter the lateral system 3 is horizontally moved from the standby position P1b into the imaging area R as shown in FIG. 11C. The lateral system 3 is set in the commanded setting position, and then the frontal system 2 is retracted into another standby position P2a. When the multi-system setting command switch 53 is pressed down, the frontal system 2 is firstly moved into the setting position P0 within the imaging area R, and thereafter the lateral system 3 is horizontally moved from the standby position P1b into the imaging area R as shown in FIG. 11D.

Although the path is set where the frontal system 2 does not contact the lateral system 3, the arms may contact to each other or the arm may contact the bed 1 depending on a rotation angle of the arm. In this case, the CPU 41 shown in FIG. 3 calculates relative position information of the frontal system 2, the lateral system 3, and the bed 1 in accordance with three-dimensional model contour data of the frontal system 2, the lateral system 3, and the bed 1 registered in advance, and moves each system in accordance with the calculated results. Thereby, impact of the frontal system 2, the lateral system 3, and the bed 1 can be avoided. Moreover, in order to prevent the subject M and the operator from impacting the frontal system 2 and the lateral system 3, a proximity sensor 71 may be disposed on at least either the frontal system 2 or the lateral system 3.

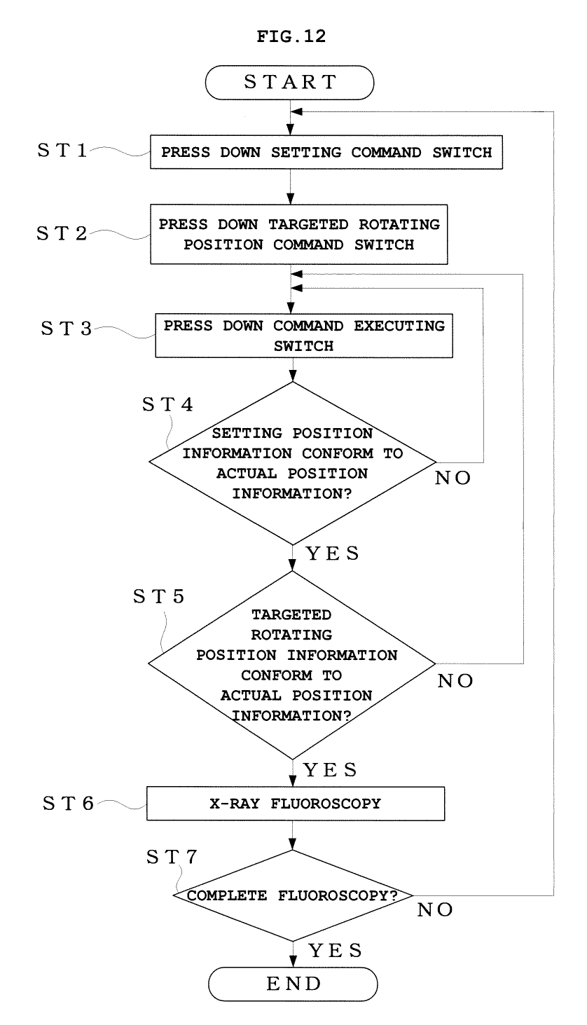

Next, operation of the fluoroscopic X-ray apparatus will be described with reference to FIG. 12.

An operator presses down a desired switch selected from the frontal-system setting command switch 51, the lateral-system setting command switch 52, and the multi-system setting command switch 53 arranged on the operating panel 40 (Step ST1.) For instance, when fluoroscopy with double system is desired, the double-system setting command switch 53 is pressed down.

The CPU 41 reads out setting position information stored in the setting positional memory 45 in response to the setting position command switch pressed down in Step ST1. Here, the multi-system setting command switch 51 is selected in Step ST1, and thus a path corresponding to the current position of the frontal system 2 and the lateral system 3 is read out from the setting positional memory 45.

For instance, as shown in FIG. 9A, where the frontal system 2 and the lateral system 3 are set in the standby positions P1a, P1b, respectively, the path of the current position P1 and the setting position Bi shown in FIG. 5 is read out.

Subsequently, the operator presses down a switch, corresponding to the clinical angle, selected from the nine targeted rotating position switches 54 arranged on the operating panel 40. For instance, a rotation direction and a rotation angle for contrast radiography and circulatory system contrast radiography, etc., are set as the clinical angle.

The CPU 41 reads out data of the targeted rotating position information memory 43 in response to the targeted rotating position command switch pressed down in Step ST2. For instance, the CPU 41 reads out given rotation direction and direction from addresses of the targeted rotating position information memory 40 in response to the targeted rotating position command switch 54.

The command executing switch 55 is pressed down (Step ST3). While the command executing switch 55 is pressed down, the CPU 41 horizontally moves the frontal system 2 and the lateral system 3 such that the setting position information read out in step ST1 conforms to the actual position information (Step ST4). Where the setting position information does not conform to the actual position information, the command executing switch 55 is continuously pressed down until the setting position information conforms to the actual position information. When the setting position information conforms to the actual position information, the process successively proceeds to the next step.

When the setting position information conforms to the actual position information in Step ST4, the command executing switch 55 is still continuously pressed down. As a result, the CPU 41 rotates the C-shaped arm 23 and the Ω-shaped arm 34 such that the targeted rotating position information read out in Step ST2 conforms to the actual position information (Step ST5.) Where the targeted rotating position information does not conform to the actual position information, the command executing switch 55 is continuously pressed down until the targeted rotating position information conforms to the actual position information. When the targeted rotating position information conforms to the actual position information, control is stopped.

X-ray fluoroscopy is performed in the targeted rotating position (Step ST6). Where X-ray fluoroscopy in different directions is needed, the process returns to Step ST1, and then Steps ST1 to ST6 are repeatedly performed.

According to this example of the invention, the operator presses down the multi-system setting command switch 53 and the targeted rotating position command switch 54. When the command executing switch 55 is pressed down, the CPU 41 reads out from the setting position information memory 45 the path of the frontal system 2 and the lateral system 3 from the current position to the setting position, and reads out from the targeted rotating position information memory 43 the rotation direction and angle. The CPU 41 rotates the drive motors M2, M4 to move the frontal system 2 and the lateral system 3 horizontally along the read-out path toward the commanded setting position. When the commanded setting position information conforms to the actual position information detected from the encoders D2, D4, the CPU 41 stops rotation of the drive motors M2, M4. Subsequent to stopping rotation of the drive motors M2, M4, the CPU 41 rotates the drive motors Ml, M3 to rotate the frontal system 2 and the lateral system 3 in the commanded rotation direction at the commanded rotation angle, and acquires the actual position information of the frontal system 2 and the lateral system 3 outputted from the rotary encoders D1, D3. When the commanded rotation direction and angle conform to the detected actual position information, the CPU 41 stops rotation of the drive motors M1, M3. Consequently, the fluoroscopic X-ray system can be moved smoothly from the standby position via the setting position into the targeted rotating position.

According to this example of the invention, the command executing switch 55 is pressed down, thereby commanding a path of the frontal system 2 and the lateral system 3 between the fluoroscopy area and the standby position determined in advance as the setting position information (e.g., the path shown in FIGS. 5 and 6) as well as the rotation direction and angle in the fluoroscopy area as the targeted rotating position information of the frontal system 2 and the lateral system 3.

Thereby the frontal system 2 and the lateral system 3 are horizontally moved along the path determined in advance between the standby position and the fluoroscopy area. Moreover, the frontal system 2 and the lateral system 3 rotate within the fluoroscopy area into a given rotation angle and a given rotation direction. Consequently, the frontal system 2 and the lateral system 3 can be moved smoothly from the standby position at a given rotation angle in a given rotation direction.

According to this example of the invention, when the frontal-system setting command switch 51 is pressed down under a state where the multi-system setting command switch 53 is pressed down and the frontal system 2 and the lateral system 3 are set within the imaging area R, the lateral system 3 is retracted into the standby position P1b registered in advance. When the frontal-system setting command switch 51 is pressed down but the lateral system 3 has already been set within the imaging area R, the lateral system 3 is retracted into the standby position P1b registered in advance and the frontal system 2 is set within the imaging area R. Consequently, upon switching the fluoroscopy with the double system into that with the single system or switching the fluoroscopy with one single-system into that with the other single-system, it is not necessary to operate each system independently, and thus the systems can readily be switched.

According to this example of the invention, the frontal system 2 and the lateral system 3 moves along the path stored in the setting position information memory 45, where they do not contact to each other. Consequently, the fluoroscopy with the double system can readily be switched into that with the single system, and vice versa.

According to this example of the invention, the CPU 41 calculates relative position information of the frontal system 2, the lateral system 3, and the bed 1, and moves the frontal system 2 and the lateral system 3 in accordance with the calculated results. Thereby, contact of the frontal system 2 and the lateral system 3 and contact of these systems and the bed 1 can be avoided.

According to this example of the invention, the frontal-system setting command switch 51, the lateral-system setting command switch 52, the multi-system setting command switch 53, and the targeted rotating position command switch 54 can be operated on one operating panel 40. Thereby, an operator of the fluoroscopic X-ray apparatus can smoothly move each system from the standby position via the setting position into the targeted movable position or can perform switching between the multi-system and the single-system with less operation.

According to this example of the invention, the frontal system 2 is a ceiling-suspension type fluoroscopy system capable of travelling on the ceiling, and the lateral system 3 is a floor-installation type fluoroscopy system capable of travelling on the floor. Thereby, the ceiling-suspension type and floor-installation type fluoroscopy systems can be moved smoothly from the standby position into a given rotation angle and a given rotation direction.

(1) In the foregoing example, the biplane fluoroscopic X-ray apparatus has been described. This is not limitative. A single-plane fluoroscopic X-ray apparatus may be adopted. In this case, the operating section 40 includes thereon a setting position command switch in response to a single fluoroscopic X-ray system, the command executing switch 55, and the targeted rotating position command switch 54. When these switches are pressed down, the fluoroscopic X-ray system is moved horizontally such that setting position information conforms to the actual position information. When the setting position information conforms to the actual position information, the fluoroscopic X-ray system is rotated such that targeted rotating position information conforms to the actual position information. Moreover, the fluoroscopic X-ray system may be any of ceiling-suspension type and floor-installation type fluoroscopy systems.

(2) In the foregoing example, the frontal system 2 is floor-installation type, and the lateral system 3 is ceiling-suspension type. This is not limitative. The frontal system 2 may be ceiling-suspension type, and the lateral system 3 may be floor-installation type. Alternatively, both the frontal system 2 and the lateral system 3 may be ceiling-suspension type or floor-installation type.

(3) In the foregoing example, the operating panel 40 includes thereon the frontal-system setting command switch 51, the lateral-system setting command switch 52, the multi-system setting command switch 53, and the command executing switch 55. This is not limitative. Any of these switches may be arranged on the grip 56.

(4) It has been described in the foregoing example, as one preferable example, that the frontal-system setting command switch 51, the lateral-system setting command switch 52, the multi-system setting command switch 53, the targeted rotating position command switches 54, and the command executing switch 55 are arranged on one operating panel 40. Any of these switches may be arranged on a different operating panel as long as they each perform the same function.

(5) The foregoing example has been described taking the FPD 25, 26 as one example of the X-ray detector. The X-ray detector may be an image intensifier.

(6) The foregoing example has been described taking P1a, P2a as the standby position of the frontal system 2, and taking P1b, P2b as that of the lateral system 3. This is not limitative for the standby position of the frontal system 2 and the lateral system 3. Another standby position may be registered in advance.

(7) In the foregoing example, the setting position information and the targeted rotating position information of the frontal system 2 and the lateral system 3 are commanded via the frontal-system setting command switch 51, the lateral-system setting command switch 52, the multi-system setting command switch 53, and the targeted rotating position command switches 54. This is not limitative. An input device, not shown, such as a touch panel may input the setting position information and the targeted rotating position information directly to execute commands. Thereby, when the setting position information and the targeted rotating position information is not determined in advance, the frontal system 2 and the lateral system 3 can be moved from the standby position into the targeted position in accordance with the inputted setting position information and targeted rotating position information.

1. A fluoroscopic X-ray apparatus for performing X-ray fluoroscopy on a subject in various directions, comprising:
a fluoroscopy system that is composed of a supporting device that supports an X-ray tube and an X-ray detector as to face to each other, and can rotate and move horizontally relative to the subject with the back thereof being placed on a bed;
a position detecting device for detecting actual position information of the supporting device around the subject;
a setting position command device for commanding setting position information associated with an area where the supporting device is set and fluoroscopy can be performed;
a targeted rotating position command device for commanding targeted rotating position information associated with a targeted rotating position for the supporting device;
a command executing device for executing setting position commands and rotating position commands from the setting position command device and the targeted rotating position command device; and
a position control device that successively performs control of horizontal movement of the supporting device such that the setting position information conforms to the actual position information outputted from the position detecting device and performing control of rotation of the supporting device such that the targeted rotating position information conforms to the actual position information when the command executing device executes the setting position commands and the rotating position commands.

2. The fluoroscopic X-ray apparatus according to claim 1, wherein
the setting position command device commands a path of the fluoroscopy system determined in advance between a standby position and the fluoroscopic area as the setting position information, and
the targeted rotating position command device commands the rotation direction and angle of the fluoroscopy system within the fluoroscopy area as the targeted rotating position information.

3. The fluoroscopic X-ray apparatus according to claim 1, wherein
the setting position command device is a setting memory switch associated with the setting position information,
the targeted rotating position command device is a two or more rotating memory switches associated with the targeted rotating position information, and
the command executing device is such a memory executing switch that when receiving commands from both the setting memory switch and the rotating memory switches, the command executing device executes the commands from the both switches in common, and when receiving commands from either the setting memory switch or the rotating memory switches, the command executing device executes the commands from one of the switches.

4. The fluoroscopic X-ray apparatus according to claim 3, wherein
the setting memory switch, the rotating memory switches, and the memory executing switch are disposed on one operating panel.

5. The fluoroscopic X-ray apparatus according to claim 1, further comprising:
an input device, instead of the setting position command device and the targeted rotating position command device, for inputting the setting position information and the targeted rotating position information.

6. The fluoroscopic X-ray apparatus according to claim 1, wherein
the fluoroscopy system has a double system, and
when the setting position command device and the targeted rotating position command device command setting positions for the double system, the position control device successively performs control of the supporting device for each the system as to move horizontally such that the setting position information conforms to the actual position information, and performs control of the supporting device for each the system as to rotate such that the targeted position information for each of the double system conforms to the actual position information.

7. The fluoroscopic X-ray apparatus according to claim 6, wherein
the setting position command device commands a path of the fluoroscopy system determined in advance between a standby position and the fluoroscopic area as the setting position information for each of the double system, and
the targeted rotating position command device commands the rotation direction and angle of the fluoroscopy system within the fluoroscopy area as the targeted rotating position information for each of the double system.

8. The fluoroscopic X-ray apparatus according to claim 6, wherein
the fluoroscopy system is a double system, and
when the setting position command device and the targeted rotating position command device command setting positions for a single system, the position control device retracts the other system already set within the fluoroscopy area into a standby position registered in advance.

9. The fluoroscopic X-ray apparatus according to claim 6, wherein
the position control device moves the fluoroscopy system along the path where the systems set in advance do not come into contact with each other.

10. The fluoroscopic X-ray apparatus according to claim 6, wherein
the position control device calculates relative position information of each of the systems and the bed, and prevents contact of at least one system to the other system or one system to the bed in accordance with the calculated relative position information.

11. The fluoroscopic X-ray apparatus according to claim 6, wherein
the setting position command device is a setting memory switch associated with the setting position information of the double system,
the targeted rotating position command device is a two or more rotating memory switches associated with the targeted rotating position information of the double system, and
the command executing device is such a memory executing switch that when receiving commands from both the setting memory switch and the rotating memory switches, the command executing device executes the commands from the both in common, and when receiving commands from either the setting memory switch or the rotating memory switches, the command executing device executes the commands from one of the switches.

12. The fluoroscopic X-ray apparatus according to claim 11, wherein
the setting memory switch, the rotating memory switches, and the memory executing switch are disposed on one operating panel.

13. The fluoroscopic X-ray apparatus according to claim 6, further comprising:
an input device, instead of the setting position command device and the targeted rotating position command device, for inputting the setting position information and the targeted rotating position information.

14. The fluoroscopic X-ray apparatus according to claim 6, wherein
one of the double system is a ceiling-suspension type fluoroscopy system capable of travelling on the ceiling, and the other is a floor-installation type fluoroscopy system capable of travelling on the floor.
